(19) United States
(12) Patent Application Publication
(10) Pub. No.: US 2008/0100993 A1
(43) Pub. Date: May 1, 2008

(54) Support Platform for Electrical Components, and Module Comprising Said Support Platform

(76) Inventors: Rudolf Muller, Pfeffenhausen (DE); Harald Vetter, Heidenheim (DE)

Correspondence Address: FISH & RICHARDSON PC, P.O. BOX 1022, MINNEAPOLIS, MN, 55440-1022, US

(21) Appl. No.: 10/593,058

(22) PCT Filed: Feb. 25, 2005
(86) PCT No.: PCT/EP05/00323

§ 371 Date: Jul. 12, 2007

(30) Foreign Application Priority Data
Mar. 18, 2004 (DE) 10200413477.4

(51) Int. Cl. H02B 1/26

(52) U.S. Cl. 361/624; 361/622

(57) ABSTRACT

A module connects a network having a power mains to a housing. The module includes a platform for holding electrical components. The platform includes a body made of a fiber-composite material and reinforcing glass fibers, a busbar in the body, and a contact element associated with the busbar for making contact with the busbar. A hood is connected to the body. A functional unit is in the hood. The functional unit includes at least one capacitor per current phase of the power mains.

### TECHNICAL FIELD

A carrier platform, as well as an electrical module with the carrier platform and electronic components, in particular, a module embodied as a power network compensation device, is disclosed.

### BACKGROUND

A carrier platform is known from EP 0 387 845.

### SUMMARY

A carrier platform is based on the idea of making available a stable and efficient carrier platform formed of an insulating material, that is suitable for mounting electrical components, especially components for power electronics and energy distribution, which together form a functional unit, in which current conductors that can be used for high currents can be integrated. As the material of the carrier platform, a fiber-composite material that contains a portion of reinforcing glass fibers can be selected. The carrier platform made from a fiber-composite material can be produced in an economical molding process.

Instead of glass fibers, other suitable fibers can also be used as the reinforcing fibers in the fiber-composite material.

A carrier platform with a molded body is disclosed, which contains a fiber-composite material with a portion of reinforcing fibers. In the molded body there is at least one busbar, which can be contacted via contact elements.

In an advantageous embodiment, the contact elements each have a contact area that is open and thus accessible from outside of the carrier platform. The busbars may be integrated into the molded body at least partially with a positive fit or are embedded in the molded body.

The busbars may be one-part current conductors. The term busbar is understood to be a current conductor that can carry a current intensity of at least 20 A, e.g., at least 100 A, without breaking down. The busbars—e.g., copper rails—are embodied, e.g., as ribbon lines.

In principle, any current conductors, even multiple-part current conductors can be integrated and especially embedded at least partially or completely in the molded body. The integration of the current conductors, especially in the case of embedding, means that the current conductor is surrounded in the circumferential direction on all sides by material of the molded body, i.e., fiber-composite material. The current conductors or busbars can have a cross section with any shape, especially a rectangular or round shape.

In one embodiment, only the contact areas of one busbar are open, i.e., the contact areas are accessible from the outside. One of the busbars corresponds to a contact strip. A contact strip includes a busbar, which can have a flat or round cross section, and can have at least two contact elements, which are upright on the busbar or vertical, which are arranged, e.g., on different ends or on different branches of the busbar, and which form in particular, internal terminals of the carrier platform for connecting electronic components. The contact elements are connected electrically, and are mechanically fixed to the busbar, e.g., by welding, and can be covered by plastic or encased in plastic at least partially, but maybe completely up to its open contact area.

In one variant of the platform, there is no separate vertical contact element, because the busbar itself has contact areas that are open, and therefore can be contacted from the outside and which can also be used as contact elements.

A supply line can have a busbar and one or more vertical contact elements for contacting components. A supply line can also have, in addition to a busbar, on one side at least one vertical contact element for contacting a component and, on the other side, an external terminal or other contact element for external contacting.

In the molded body, contact elements may be integrated as internal terminals for connecting components. Through geometric shaping of the molded body or a hood used for forming a closed housing, installation sites, in which certain electrical components are fitted, can be defined. At least two internal terminals are allocated to one installation site. External terminals can be formed on the molded body of the carrier platform. However, the external terminals can also be formed by parts of the busbars integrated in the molded body and projecting from the molded body.

Different components are connected electrically to each other or to external terminals by electrical supply lines (current conductors), wherein at least one part of the supply lines is integrated in the carrier platform at least partially with a form fit, e.g., by a casting or molding process.

An internal terminal for connecting components contained in the module or an external terminal for external wiring of the module can be connected directly to a supply line or busbar or formed as an open contact area of the corresponding busbar. It is possible for at least one supply line to be formed, e.g., as a phase busbar, which may have external terminals that are accessible from the outside at its two ends projecting from the molded body.

At least two vertical contact elements may be allocated to one installation site. These contact elements may have a mounting device for mounting the component or are suitable themselves for mounting such a component, e.g., through screws or plugs. The vertical contact elements may be cylindrical and can have an internal thread. The vertical contact elements alternatively can each be formed in the form of a bushing, which may be provided with spring contacts and has an opening as a mounting device for receiving plug contacts (of a component).

The vertical contact elements may be arranged in the body of the carrier platform, so that only their mounting device is exposed. The mounting device is connected to a terminal of the component by attachment devices, e.g., attachment bolts, plugs, or clips.

Alternatively, the vertical contact elements can each be formed as a plug or threaded bolt, which projects from the molded body and which can be connected to a correspondingly shaped attachment device, in this case a bushing or a screw nut.

In principle, a mechanical connection by attachment devices can be replaced by a monolithic connection (e.g., a weld connection) and vice versa.

A carrier platform described here has the advantage that the supply lines do not require an additional insulating sleeve due to their integration in the molded body of the carrier platform. By integrating the current conductors into the carrier platform, the expense for the manual assembly of the electrical terminals is eliminated.

A fixed, form-fit connection—especially embedding, e.g., by casting, bonding, or molding—between the integrated current conductors and the molded body of the carrier platform has advantages, due to the high mechanical stability of the molded body, relative to the known multiple-part lead-through devices, which are configured, e.g., as plug connections, which are known for applications with plastic housings, and which electrically connect the external terminals of a functional unit to the terminals of the corresponding assembly.

The embedding of current conductors, especially electrical lead-through elements, has the advantage that a hermetic or sufficiently gas-tight module area can be created.

Embedding busbars in the molded body of the carrier platform is advantageous when the coefficient of thermal expansion of the busbar material is adapted to the coefficient of thermal expansion of the carrier platform material, i.e., when the relative difference of the expansion coefficients does not exceed a given threshold β. According to the requirements of the application, β can equal, e.g., 10%, 20%, or 30%. Ideally, the expansion coefficients of the metal of the embedded current conductors and the plastic of the platform body are adapted to each other precisely (β≦0.01).

A fiber-composite material may be composed of a polymer and a portion of glass fibers, which are embedded in a polymer matrix. The glass fibers provide mechanical strength of the carrier platform, while the polymer, which is used among other things for bonding glass fibers, can guarantee a high insulating strength and seal for the platform.

The carrier platform may be used (as part of a housing) for setting up a modular system for improving the energy quality of low-voltage power mains. Here, it involves power network compensation devices, also called reactive-power compensators, which may be set up as housed modules. Such a module may have a number of external terminals corresponding to the number of current phases.

In a power-factor correcting unit phase busbars are integrated, in the body of the carrier platform, as current conductors, which can be connected to a power network. The phase busbars are integrated or embedded in the body of the carrier platform, e.g., with a positive fit, and are connected to supply lines leading to module components. The number of phase busbars corresponds to the number of current phases in the power network. Therefore, for three-phase applications, three parallel phase busbars may be provided in the carrier platform. In one embodiment, each phase busbar has external terminals on its two ends and is connected in parallel to the power mains line between the power mains operator and the power mains load.

In a power-factor correcting unit, the carrier platform described here forms the basis of a common housing for (e.g., all) functionally relevant module components, with the components being able to be installed in the housing, in particular, “naked,” i.e., as unhoused components, in order to reduce material costs for housing the individual components, assembly costs, and installation volume. Therefore, most or all of the components may be unhoused.

In addition, a reactive-power compensator is disclosed, in which unhoused electrical components are arranged on a common platform and wherein, a housing common to at least one part of the electrical components is arranged on the platform. The platform need not necessarily have the properties described in detail here. In particular, capacitors without individual housings, as well as contactors and safety devices, can be arranged in the given module. Also, the breakers and the contactors may not have individual housings, but instead are unhoused or “naked.” By eliminating individual housings and by simultaneously forming a common housing for several components, the volume can be reduced. In addition, the weight can be reduced and the production costs for such a module can also be reduced.

In addition to the cost effectiveness, the described modules offer the possibility of standardization, which means that a standardized module suitable for a certain electrical power to be regulated is defined, and that for regulating a given electrical reactive power, the number of required identical modules can be easily connected one behind the other into one large power network compensation device. This offers the advantage, in comparison with conventional small job series, that an industrial mass production is allowed with lower production costs.

Based on the carrier platform described here, new technical solutions, e.g., dynamic power-factor correction, can also be realized. In particular, it is possible to also use unhoused semiconductor switching elements in the module for active power-factor correction.

At least one hood can be arranged on the molded body of the carrier platform for forming a housing. In an embodiment, a hood is provided on opposing sides of the molded body, with a first hood being made of, e.g., metal such as stainless steel, as a tightly closing hood and a second, e.g., removable hood, being made from plastic. Such a differentiated housing design can create, in particular, optimum initial conditions for the components to be used, if, e.g., the metal hood is used for housing capacitors and the plastic hood for housing passive or active switching devices or switching elements.

The proposed design of a power module provides, in particular, for the fulfillment of important fire-safety standards and the demand for position-independent installation, and is environmentally friendly.

The functional unit of a power-factor correction module may be divided into several function groups, which are each housed in a separate hollow space or module area, i.e., separately from the other functional groups of the same module. A separate module area may be isolated mechanically from the other module areas is allocated to each functional group.

One functional group may be composed of several electrically interconnected, e.g., identical components, or alternatively of several different components each realizing at least one part of a defined compensation circuit. Thus, a functional group can be composed of components, which are allocated to different current phases, or of several components of a circuit branch allocated to one current phase. The power capacitors may form a unique (first) functional group, while most or all of the other components of the functional unit form a second housed functional group.

Mounting points on the carrier platform can be formed as inserts, i.e., as bushings with a through-hole or pocket hole and an internal thread or also in some other way in the form of mounting areas. In the carrier platform of a module with several housed module areas, electrical lead-through elements may be integrated or at least partially embedded, which electrically interconnect the module areas.

In one embodiment, the molded body of the carrier platform is formed, e.g., in two parts, with recesses for receiving busbars, especially phase busbars, formed on its side facing inwards (i.e., towards the other part) in at least one of the parts of the molded body. The parts of the carrier platform can be, e.g., bonded, screwed, or mechanically fixed in some other way with each other and to the busbars after the arrangement of the busbars.

A power network compensation device with the function of a phase shifter is also disclosed. A phase shifter module is composed of a functional unit, which is composed of at least one capacitor per current phase, this capacitor representing, e.g., a power capacitor. The functional unit can further have a switching device—e.g., a switching conductor—and at least one safety device per current phase.

For compensating for the phase shift between the current and voltage in the power mains, it may be useful to use self-sealing three-phase power capacitors which can be fully impregnated or produced using dry technology.

In a phase shifter or power mains filter module described here, dry three-phase MKK capacitors (MKK=metallized plastic film, compact construction) are used as power capacitors. Oil-filled and oil-impregnated capacitors can also be used. A capacitor can be formed as a round, laminated, or flat coil. Instead of an individual capacitor, a capacitor coil package can be used for the capacitance of the module. This package is composed of a defined number of mechanically fixed, individual capacitor coils are electrically interconnected by current conductors, e.g., in a triangle or star arrangement.

The number of capacitor coils in a package for three phases may be 3N, N=1, 2 . . . . Here, the capacitor coil package may be “naked,” i.e., unhoused in the module housing, e.g., arranged in a hermetically closed first module area. The hermetic closure between the housing parts—i.e., between the molded body and a hood which may be formed as a metal hood, can be realized, e.g., through bonding or screws and with the use of a matching sealant.

The switching of power capacitors, especially when they are switched in parallel to other, already charged capacitors, can cause high peak voltages and high switch-on currents, which reduces the service life of the capacitors. For damping this loading, a capacitor connector construction with pre-charging resistors can be used, e.g., essentially without housing. In the functional group, capacitor discharge devices, such as discharge inductors and/or discharge resistors, can be used, wherein the discharge inductors can be embodied, e.g., as air-core coils.

Safety elements can be provided with holders, but may be implemented essentially without housing.

Safety devices, e.g., a temperature sensor or an overpressure switch, can also be contained in the functional unit and placed in the module housing. In some embodiments, the module offers several independent safety devices: an pressure-relief switch and a temperature-sensitive switch. In addition, optionally an overpressure tearing safety device can be installed.

The overpressure tearing safety device can be realized in the capacitor area of the module, e.g., by selecting the tearing force and the tearing path of a safety device wire, such that the hood provides sufficient deformation paths and tearing force when there is overpressure in the capacitor area, especially at the end of the service life of the self-sealing capacitors or in the case of a fault in order to break the safety device wire.

In particular, a safety device is disclosed for a capacitor, in which a temperature switch is arranged in the vicinity of a point of high thermal power (also called a hot spot). The temperature switch can be, for example, a temperature-dependent microswitch based on a bimetal switch. When the capacitor overheats, the temperature-dependent microswitch switches, and can activate, for example, a contactor or some other switching device used in the modules disclosed here, in order to remove the capacitor from the power mains or to switch it off and therefore to prevent further heating of the capacitor and destruction of the entire arrangement.

The temperature switch may be arranged in the interior of the central column of the capacitor. The central column may be hollow in the interior and is wound on the outside with the capacitor coil. The safety device may be used with unhoused capacitors or with capacitors, of which one or more are installed in a module disclosed here. In particular, capacitors that can process an electrical reactive power of 12.5 to 50 kvar per capacitor coil are taken into account.

In addition, the safety design described here can be expanded by a pressure switch, which senses the pressure in a capacitor housing or in a housing with several unhoused individual capacitor coils and which is also coupled to a switching device. When the pressure increases above a given threshold, the pressure switch actuates the switching device and this, in turn, separates the capacitor from the power mains.

The pressure switch can also be placed in the second functional group, for example, for reasons of space or in order to not expose it to the heat of the first functional group, i.e., so that the pressure switch is placed on the side of the platform opposite the first functional group. In this case, it is advantageous if the pressure coupling of the overpressure switch with the capacitors is realized via an insert pressed into the platform. In the simplest case, this can be a metallic sleeve made, for example, from brass, which has a through-hole, so that the two volumes of the first functional group and the second functional group can be coupled. With suitable sealing measures, for example, sealing rings that are used to seal the pressure sensor from the surroundings when the insert is pushed in, a sufficient sealing of the tightly closed module area containing the capacitors can also be guaranteed.

Mounting devices for fastening control or signal lines for the switch or sensor can also be placed on the housing of the module or in the interior of the housing.

The module can have an element, e.g., integrated in the housing cover, with a display that is visible from the outside, e.g., “on/off,” which indicates the operating state of the module, or at least one corresponding light element, e.g., a red or a green lamp.

In another variant, a module with the function of a power mains filter can be provided as a power network compensation device.

A power network compensation device designed as a power mains filter can also include, just like a device provided for the power-factor correction, in addition to power capacitors, e.g., the following components: filtering circuit chokes as inductors, discharge chokes or discharge resistors, safety devices or load-break switches, control assemblies, e.g., temperature sensors and switching devices, e.g., switching contactors or dynamic switching elements, such as thyristors.

In addition, a device for power-factor correction is disclosed, in which, a switching device for switching the capacitors on or off can also be provided, in addition to one or more capacitors, which can also process, if necessary, very high electrical powers. Such a switching device can be given, for example, by a switching contactor. However, a switching device can also be realized by one or more thyristors. Thyristors have the advantage that they allow a dynamic switching process, i.e., the capacitor is coupled, to a certain extent, “smoothly” to the power mains. Therefore, transient events in the power mains, i.e., the appearance of harmonic oscillations, can be prevented to a large extent. In addition, the use of thyristors also has the advantage that they experience only extremely low wear and thus a nearly arbitrary number of switching processes can be performed for switching the capacitors on or off.

In addition, a power-factor correction module is also disclosed that can process a high electrical reactive power with a very small volume and also a very small weight. In particular, a module is disclosed that can process a reactive power greater than 20 kvar. In particular, a module is disclosed that can process a reactive power of 50 to 100 kvar, as well as greater than 100 kvar. Such a module has a weight that may be less than 50 kg, in particular, a module is disclosed with a weight between 20 and 50 kg, e.g., between 33 and 38 kg. The module disclosed here also has very small dimensions, in particular, the module requires an enclosed volume that is less than 100 L. In particular, the necessary volume equals between 20 and 50 L, e.g., 39 to 53 L.

A module that fulfills the characteristics named above in terms of electrical power, weight, and volume can be realized, for example, by using a carrier platform described above in connection with unhoused electrical power capacitors, as well as in connection with optionally similarly unhoused switching elements such as contactors or thyristors.

A module designed as a power mains filter may include a choked capacitor, i.e., a series circuit made from a capacitor and an inductor may be selected as a choke coil (three-phase current coil). Thus, a series resonant circuit, whose resonance frequency is set, e.g., by the design of the choke, e.g., so that it lies below a limiting frequency, for example, of the fifth harmonic frequency (250 Hz). In principle, any resonant circuit design can be realized. In this way, the choked capacitor has an inductive effect for all higher harmonic frequencies, which can damp dangerous resonances between the capacitor and power mains inductors at higher frequencies. Other components named above can also be contained in the power mains filter module.

Power network compensation devices are switched by reactive-power control units, which can be provided, e.g., as a separate module and which can be connected to the power network compensation modules.

In addition, an electronic module is disclosed embodied on the basis of the carrier platform described here. In addition to the carrier platform, one or more capacitors are optionally installed in a housing. The capacitors can involve power capacitors. The module can be applied for many different purposes and need not necessarily be used for the compensation of reactive currents.

Instead, functions such as the filtering of harmonics or the use as a harmonic-oscillation filter are also conceivable.

In addition, a modular device for phase shifting between the current and voltage in a power network is disclosed. The device can also be used as a power-factor correction device. The device can contain one or more phase-shifting modules connected one behind the other. In particular, the phase-shifting modules described here can include those that can each process, for example, an electrical reactive power of 50 to 100 kvar. The modular construction has the advantage that a flexible adaptation to the given requirements is possible. For example, a phase-shifting device with an electrical power of 200 kvar can be constructed by connecting two phase-shifting modules, each with an electrical power of 100 kvar. With the compact individual modules described here, the entire phase-shifting device can also be realized very economically in terms of space and weight. In addition, the device has the advantage that a flexible adaptation to smaller or larger reactive powers to be processed is possible.

The devices described above will be explained in more detail below with reference to embodiments and the associated figures. The figures show different examples with reference to schematic representations, not drawn to scale. Identical or equivalent parts are designated with the same reference symbols.

### DESCRIPTION OF THE DRAWINGS

FIGS. 1A, 1B, 1C each show a schematic plan view of a module.

FIG. 1D shows a variant of the housing with a carrier platform in schematic cross section.

FIG. 2 shows a block circuit diagram of a functional unit which is suitable for power-factor correction and includes three-phase current capacitors, discharge chokes or resistors, three-phase current chokes, safety devices, phase busbars, and a capacitor connector.

FIG. 3 shows a delta connection of individual compact LC elements.

FIG. 4 shows the construction of an example LC element.

FIG. 5 shows a schematic circuit diagram of the LC element from FIG. 4.

FIG. 6 shows another compensation module in schematic cross section perpendicular to the axes of the phase busbars.

FIG. 7 shows an example construction of electrical supply lines.

FIG. 8 shows a schematic cross section of the carrier platform shown in FIG. 9.

FIG. 9 shows a module from FIG. 6 in a schematic cross section parallel to the axes of the phase busbars and perpendicular to the plane in which the axes of the phase busbars lie.

FIG. 10 shows a module from FIG. 6 in a schematic cross section parallel to the plane in which the axes of the phase busbars lie.

FIG. 11A shows another module in a schematic cross section perpendicular to the axes of the phase busbars.

FIG. 11B shows the module from FIG. 11A in another schematic cross section parallel to the axes of the phase busbars and perpendicular to the plane in which the axes of the phase busbars lie.

FIG. 12A shows, in a perspective view, the construction of internal terminals of the phase busbars integrated in the molded body of the carrier platform.

FIG. 12B shows a section of another perspective view of the arrangement from FIG. 12a.

FIG. 13A shows an example of a construction of an electrical lead-through, which is embedded in the carrier platform, in a broken representation.

FIG. 13B shows an example of a construction of internal terminals of the integrated phase busbars.

FIG. 14 shows a modular phase-shifting device.

FIGS. 15 and 16 show a safety device design.

FIG. 17 shows the coefficient of thermal expansion α, which is dependent on the glass content, for different mixtures of a polyester resin with reinforcing glass.

### DETAILED DESCRIPTION

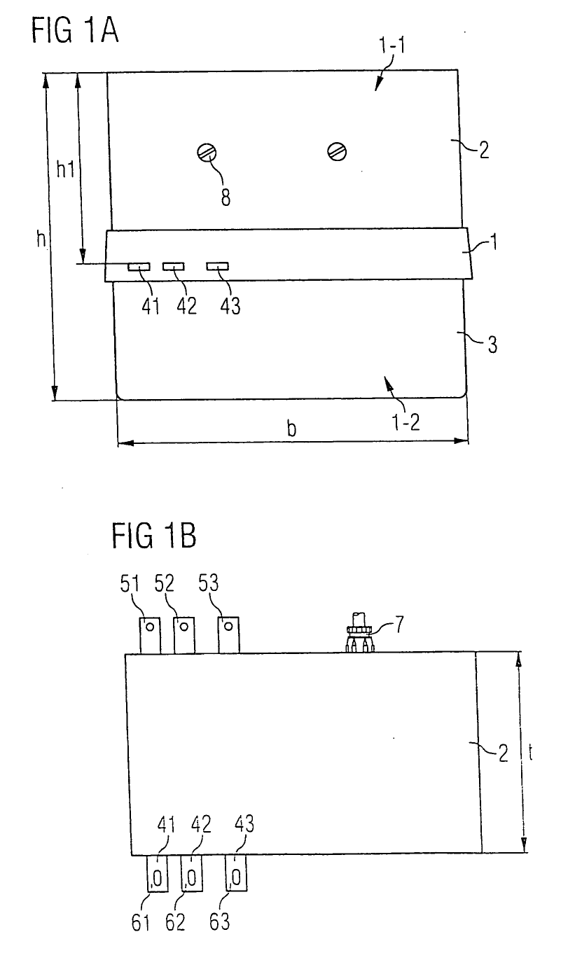

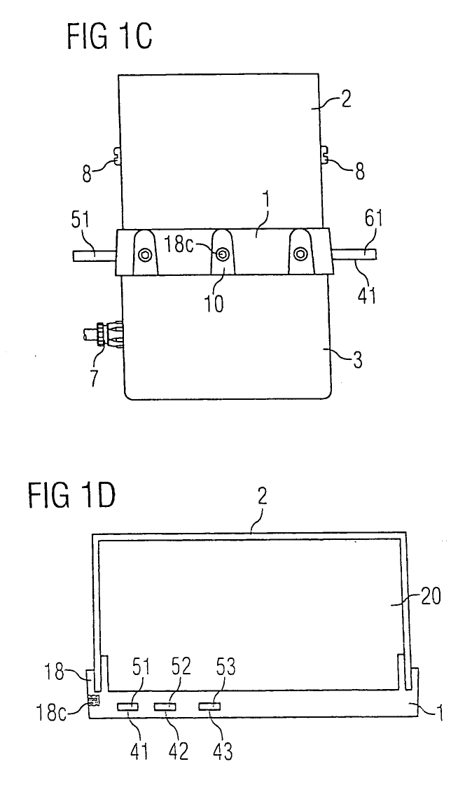

FIG. 1A shows a schematic plan view of a module, which has a molded body 1 as a carrier platform, a first hood 2, and a second hood 3. The first hood 2 may be formed from metal. The second hood can be formed from metal or plastic.

Between the molded body 1 of the carrier platform and the first hood 2, there is a first module area 1-1, which may be hermetically tightly closed and may hold capacitors. Between the molded body 1 and the second hood 3, there is a second module area 1-2. Both module areas are electrically connected to each other and to phase busbars 41, 42, 43 in part through the carrier platform, by electrical lead-throughs, not visible here, and supply lines wherein they are mechanically separated from each other by the molded body 1 of the carrier platform. The phase busbars 41, 42, 43 are embodied here as three parallel copper ribbon lines.

The phase busbars can be formed as copper rails. They may have a width of 30 mm and a thickness of 15 mm. In this way, a sufficient current carrying capacity is achieved (720 A at 50 Hz as the nominal power) and the copper rails are suitable for a maximum total power of 500 kvar electrical reactive power. This means that in a modular construction of several power-factor correction modules connected one after the other, up to five such modules can be connected in parallel, wherein each module has an electrical output of 100 kvar. In other embodiments, the thickness can also equal only 10 mm or 5 mm.

For phase shifter modules, in which a parallel circuit of several modules is not provided, it is sufficient when the busbars have a smaller cross section of, for example, 30 mm in width and 5 mm in thickness.

The geometric dimensions are not limited to the above-mentioned numerical values, instead one can also consider copper rails, whose width or thickness differs from the mentioned numerical values, but whose cross-sectional surface area corresponds approximately to the values described here. In principle, the current carrying capacity scales with the cross-sectional area. That is, when the cross section doubles, the busbar can also carry twice the current.

The cross section should not fall below 5×20 mm², corresponding to a current carrying capacity of approximately 160 A.

A part of a first 41, a second 42, and a third 43 phase busbar is embedded in the molded body 1.

The molded body can be formed so that, in addition to one or more busbars, other metallic elements, for example, lead-throughs or inserts, can also be embedded in this body. Furthermore, the molded body can be covered with a hood, which engages in a groove arranged in the molded body. To guarantee the permanent sealing of the hollow spaces formed by the molded body or by the entire carrier platform together with covering hoods in sufficient dimensions, it is advantageous if the coefficients of longitudinal expansion of the different involved materials are matched to each other.

The production of the molded body can include, in particular, reinforcing glass (for example, E-glass fiber), as well as a matrix made from largely unsaturated polyester or vinyl ester as components. The molded body can also contain a portion of mineral fillers.

It is further advantageous if the CTI value is greater than 600. Here, CTI is the abbreviation for the term “Comparative Tracking Index.” CTI is the comparison number for the formation of creepage paths. Insulation materials no longer fulfill their insulating purpose when creepage paths are created for the current due to contaminants or moisture on the surface. CTI is the maximum voltage—measured in volts—at which 50 drops of contaminated water does not cause the formation of creepage paths on the insulation material. This test is defined in IEC 112.

In addition, it is advantageous if the carrier platform or the molded body satisfies the fire-safety standard NFF 16 101/102 with relevant classification.

The mentioned requirements can be fulfilled in an especially economical way through the use of a fiber-composite material, for example, with the designation “glass fiber-reinforced polyester.” A material may be used that fulfills the requirements for SMC (=Sheet Molding Compound) or BMC (=Beetle Molding Compound). For a long-lasting sealing bond between metal and plastic, wherein here, in particular, a metal hood is used on one side of the platform, it is important that the coefficients of longitudinal expansion of the materials involved match. For a more detailed explanation of the matching of the coefficients of longitudinal expansion, the following table lists examples of information for coefficients of longitudinal expansion for possible materials, which are not all-inclusive:

| | Coefficient of longitudinal |
|---|---|
| Material | expansion α (10⁻⁶/K) |
| Steel | 13 |
| Brass | 18 |
| Copper | 16.8 |
| Reinforced glass | 5-8 |
| Polyester resin | 30-45 |

In a first embodiment of the platform, it is covered with a steel hood. For the molded body, a mixture made from polyester resin and reinforced glass in the form of a composite material is selected, wherein 30% resin and 70% reinforced glass is contained in the material. If one assumes that the resin has a coefficient of longitudinal expansion a of 35×10⁻⁶/K and the reinforced glass has a coefficient of longitudinal expansion of 6×10⁻⁶/K, then this produces a coefficient of longitudinal expansion for the composite material of approximately 14×10⁻⁶/K.

In another expansion form of the carrier platform, the coefficient of longitudinal expansion can be adapted to a busbar (copper line). Here it is useful to use a mixture of 50% resin and 50% reinforced glass, wherein, for the resin, the relevant value for a coefficient of thermal expansion a is 30×10⁻⁶/K and for the reinforced glass the relevant value for a coefficient of thermal expansion is 5×10⁻⁶/K. Then a composite material is obtained with a coefficient of longitudinal expansion a of approximately 10⁻⁶/K.

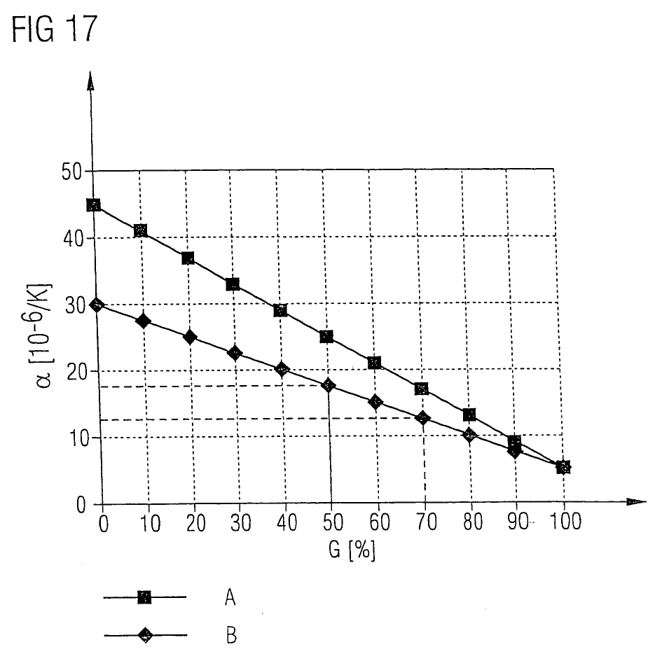

For further explanation, reference is made to the graphical representation in FIG. 17. There the expansion coefficient of a composite material is shown as a function of a glass content percentage in the composite material. The composite material also contains a resin content, wherein for two different resin materials, the dependency is indicated by the glass content for a composite material produced with the corresponding resin. FIG. 17 shows a curve A for a first resin composition and a curve B for a second resin composition. The two resin compositions differ by their coefficient of longitudinal expansion in the pure, i.e., in the glass-free state.

The graphical representation shows that the setting of the expansion coefficients may be implemented by adding a glass portion in the composite material by an assumed linear relationship between the glass content and expansion coefficient α. In addition to the glass content, another degree of freedom exists in the selection of a suitable resin from an entire group of available resins. Only two different resin materials are explained in FIG. 17 as examples.

It was also found that resins with a relatively low longitudinal expansion tend to produce rather brittle material behavior and thus lead to the formation of hairline cracks (cf. curve A). The inverse applies for resins with a somewhat greater longitudinal expansion (cf. curve B), so that the tendency to form hairline cracks is rather small. Thus, according to the requirements, if necessary, resins with greater coefficients of longitudinal expansion may be used.

On the other hand, for process-specific reasons alone, an exact matching of the coefficients of longitudinal expansion to another material embedded in the molded body cannot be realized completely. However, an adequate matching of the coefficients of longitudinal expansion is sufficient, i.e., a small difference between the coefficients of longitudinal expansion of the molded body on one hand and the coefficient of longitudinal expansion of the steel cap, the brass insert, or the copper rails on the other is definitely allowed.

In an embodiment, a glass content of 27% is used together with a suitable resin. A platform or molded body produced with such a glass content has a coefficient of longitudinal expansion a of approximately 23×10⁻⁶/K. Thus a mismatch of 10×10⁻⁶/K is produced for steel material, of 5×10⁻⁶/K for brass material, and of approximately 6×10⁻⁶/K for copper material. Such a mismatch corresponds to an embodiment of the carrier platform. If necessary, the mismatch can also be greater, for example, the platform can also have a greater coefficient of longitudinal expansion.

The use of a relatively low glass content, which is, in particular, less than that which would be necessary for setting a coefficient of longitudinal expansion <20×10⁻⁶/K (cf. here FIG. 17), is advantageous for forming very intricate structures as integral components of the molded body. In particular for the shaping of fine ribs, which stand upright on the carrier platform and which are used for insulation between components, a relatively low glass content is advantageous.

In matching the coefficients of thermal expansion, it may be attempted to achieve the best possible matching to the copper material. The steel material is relatively non-critical, because an elastic adhesive, which can easily compensate for small differences in longitudinal expansion, can also be provided, if necessary, between the platform and the steel cap. For matching the coefficients of thermal expansion to the brass material, attention must be paid that the brass material is present in the embodiments of the platform only in the form of small inserts, so that here at least small differences in the coefficient of thermal expansion are relatively non-critical. Busbars extending along a relatively long distance of the platform or the molded body have a different behavior, because infinitesimal differences in longitudinal expansion add up to a marked difference in longitudinal expansion or difference in length when the temperature increases.

In an embodiment of the carrier platform, the glass content in the fiber-composite material equals between 25 and 35 wt. %.

In this way, the glass content may be selected somewhat lower than the glass content that would be necessary for a given polyester resin and thus a fixed coefficient of longitudinal expansion of the polyester resin in light of the remarks on FIG. 17, in order to achieve an exact equalization of the coefficients of thermal expansion to the copper material. Through the reduced glass content, an improved flowability of the plastic to be processed is achieved, with which intricate configurations of the molded body are possible. In particular, the formation of several narrow upright ribs close to one another can be simplified.

In one variant of the hood 2, openings 8 are formed, which can be provided as impregnating openings or as openings for receiving mounting elements or other elements, e.g., connections of an external control device. The openings for mounting components may be arranged in at least one hood wall or in opposite side walls of the hood. However, the components can also be connected rigidly to the carrier platform.

The hood 2 may have perforated brackets, which can be angled. The brackets are fixed mechanically to the molded body 1, e.g., by screws. The corresponding interfaces can also be gas-tight or oil-tight, if necessary. The hood 3 can also be fixed to the molded body using analogous devices and methods. Alternatively, at least one of the hoods or also both of the hoods can be removed.

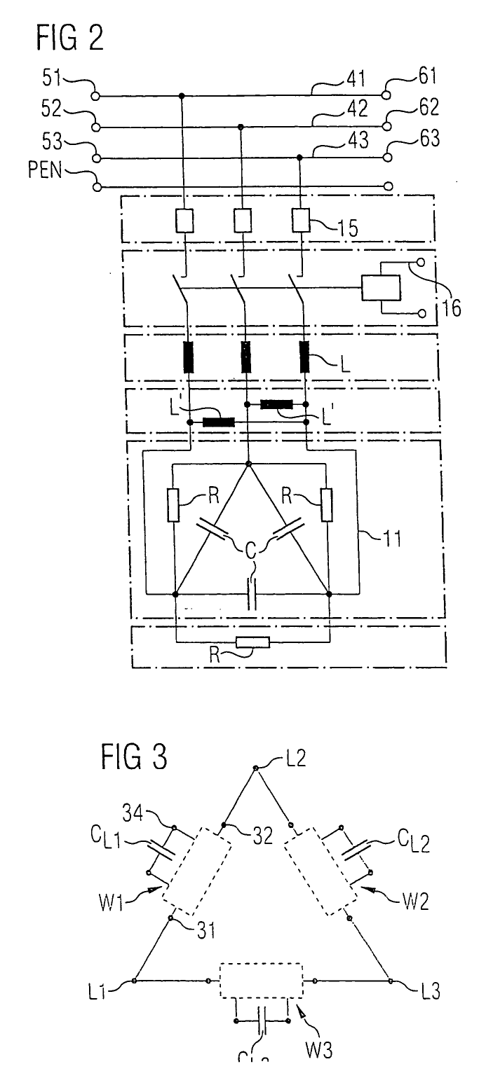

FIG. 1B shows a schematic plan view of the module from FIG. 1A. In an opening arranged in the second hood 3, there is a control terminal 7 for controlling a switching device 16 from FIG. 2. The phase busbars 41, 42, and 43 project from the carrier platform, which is not visible here, on both sides, and have first external terminals 51, 52, 53 and also second external terminals 61, 62, 63. The external terminals of the phase busbars are provided with bores or openings for receiving attachment elements.

In FIGS. 1A and 1B, examples of geometric dimensions of the power-factor correction module are also to be found. According to FIG. 1A, the height hi of the volume enclosed by the hood 2 equals approximately 260 mm. The total height h of the arrangement equals approximately 400 mm. The width b of the module equals approximately 360 mm and the depth t equals approximately 260 mm. In total, a volume of approximately 39 1 is produced, which may be used for a phase-shifting module with an electrical reactive power of 100 kvar.

FIG. 1C shows another schematic side view of the module from FIG. 1A. Inserts 18c are formed in recesses 10 of the side wall of the molded body 1. The inserts 18c may be threaded bushings, which are used for receiving fastening elements and can be connected to attachment angles, e.g., by screws.

The external walls of the molded body may be formed at a right angle to the (longitudinal) axis or base surface of the molded body, at least in the insert areas, i.e., these areas do not have bevels. This shaping has advantages when attachment angles are attached.

In FIG. 1D it is indicated that all of the power electronic components of the module can be arranged in a single, e.g., enclosed, hollow space 20.

The hood may be mounted to the molded body 1 by retaining screws embodied as self-cutting screws. The molded body can have corresponding mounting points, e.g., in the form of suitable configurations, which as used for attaching the hood 2. The attachment points of the molded body can have openings for receiving retaining screws, which may be opposite the perforated mounting brackets of the hood.

Furthermore, in the molded body 1 there is a recess 18, into which the hood 2 projects. The recess 18 may be formed as a peripheral shaft (or a peripheral groove) suitable for receiving an adhesive or sealant that seals the molded body-hood interface. A rubber piece or a rubber ring can also be used as a sealant, which, compared with a cast part, has the advantage that the hood is well sealed on one hand (i.e., is gas or oil tight) and it is removable on the other hand.

This interface can be used as a designed break point, with the removing force of the retaining devices named above for the hood being selected so that the hood tears when a defined overpressure threshold is exceeded.

The functional unit of a module can be designed, e.g., as a phase shifter or as a power mains filter. In a phase shifter, the power capacitors may form a delta connection, whose nodes can each be connected to a phase busbar 41-43, e.g., via a safety device 15 or switching device 16, cf. FIG. 2. The power capacitors can alternatively be interconnected in a star arrangement, with their free connections each being able to be connected to a phase busbar or to the corresponding circuit branch of the functional unit.

The safety device 15 may be a short-circuit safety device.

FIG. 2 shows the block circuit diagram of a functional unit suitable for power-factor correction or for filtering power mains harmonic oscillations. The capacitors C (power capacitors) are interconnected into a triangle, with each electrical node of the delta circuit being connected to a circuit branch allocated to the corresponding current phase. The circuit branches each have a safety device 15, a switching element, which can be, e.g., a switch contactor, for a three-phase switching device 16, and a three-phase current choke L, with the named components being connected one after the other in the circuit branch. The circuit branches are each connected to a phase busbar 41, 42, or 43 integrated in the module. PEN designates a neutral conductor.

In an embodiment, discharge resistors R and discharge inductors L′ are connected in parallel to the capacitors C. Either the discharge resistors R or the discharge inductors L′ can be integrated in one power capacitor.

As an alternative, the power capacitors can also be interconnected in a star arrangement in a power mains filter and connected to the corresponding circuit branches.

A monitoring unit not shown here is connected to the corresponding current conductor for monitoring the phase shift φ between current and voltage on the power mains-operator side of the power network, which is shown on the left, e.g., in the figure. When a given threshold of the phase shift is exceeded, this monitoring unit connects the functional unit of a power-factor correction module to the power network by activating the switching device 16.

As an alternative to the switch contactor in the functional unit of a module, a different, especially a dynamic switching device, e.g., a thyristor module for a dynamic power-factor correction or for separating the functional group from the power mains, can be provided. Instead of a connector switch with three switching elements in each circuit branch of the functional unit, e.g., a “naked” semiconductor switch in the form of a thyristor can be provided.

The components shown in FIG. 2 (capacitor and inductor) can form a functional group of several interconnected (compact) LC elements in one variant of a power-factor correction module, see FIGS. 3 to 5. Compact means that a component (LC element W1, W2, W3) is embodied as a housed or unhoused discrete component with electrical contacts 31, 32. The LC elements are arranged in the first or second module area and each may be connected to a load capacitor C_{L1}, C_{L2}, C_{L3}. The load capacitors C_{L1}, C_{L2}, C_{L3} can be formed as separate coil capacitors or optionally together as a three-phase coil capacitor with two insulating layers. Each load capacitor can be formed by several parallel capacitors.

A power-factor correction circuit can have modularized components, which each include several circuit elements, e.g., a combination of a capacitor and an inductor. Such an LC element can be realized by, e.g., a dry capacitor coil optionally wound concentrically around a central column.

The delta-star circuit shown in FIG. 2 with capacitors C and inductors L can be replaced in principle by a circuit of compact LC elements. An LC element may be allocated to one current phase.

FIG. 3 shows schematically in a cut-out, a functional unit that includes three electrically interconnected, compact LC elements W1, W2, W3, which are each connected to a load capacitor. An LC element may have a magnetic circuit. The LC elements are interconnected in a symmetric base circuit with three phase connections L1, L2, L3. Several LC elements may be connected in parallel to each other with a load capacitor can be provided per current phase.

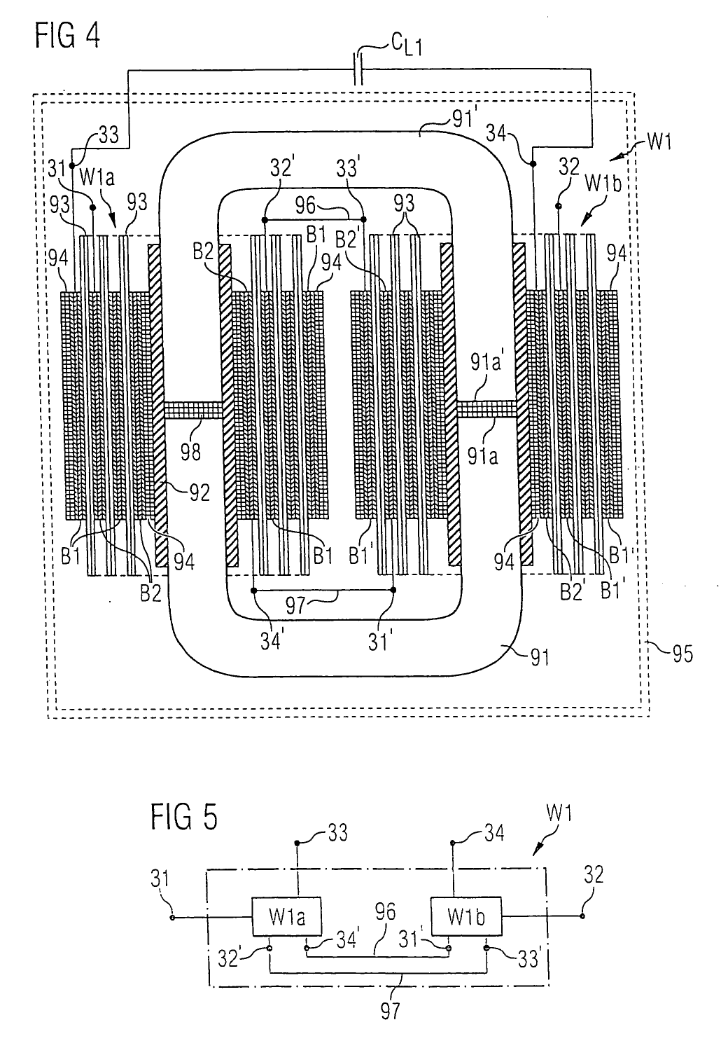

In an advantageous variant, an LC element can be formed as an LC coil with a UU magnetic circuit (i.e., with two joined U-shaped magnet cores), which is connected to an external capacitive load. The LC coil here may be formed in two parts with two LC sub-coils W1a, W1b connected in series, see FIG. 4.

The external capacitive load may correspond to the power capacitor or the capacitor C of the module, which is arranged in the first module area. The LC element may be housed and also arranged in the first module area. In this case, the LC element or the corresponding LC coil may be oil-impregnated and not self-sealing.

In the molded body of the carrier platform, recesses (caverns) for receiving LC coils or other components, as well as other correspondingly shaped depressions or shafts, can be formed for holding the U-shaped magnet cores or other components of the module.

An LC element may correspond to a single component, here with four electrical terminals (31, 32, 33, 34). The electrical terminals 31 and 32 of a first LC element W1 are provided as primary terminals (i.e., system connections in the phase direction for connecting the LC element between two current phases). The electrical terminals 33 and 34 of the first LC element W1 are provided as secondary terminals for contacting to a load capacitor C_{L1}. Analogously, a second and a third LC element W2, W3 also have primary and secondary terminals.

The primary terminals are connected to the phase terminals L1, L2, L3. The secondary terminals may be connected to an external load capacitor C_{L1}, C_{L2}, C_{L3}. The load capacitors may be formed as self-sealing capacitors.

The LC coil involves, among other things, a spiral, wound film capacitor, with the beginning and end of the two capacitor films—metal films B1 and B2—being contacted electrically to four connection points 31, 33 (at the beginning) and 32′, 34′ (at the end).

The load capacitor may be connected, as shown in FIG. 4, at the beginning of the film of the first LC sub-coil W1a and at the end of the film of the second LC sub-coil W1b. Here, the end of the metal film B1 or B1′ (B2 or B2′) facing inwards is designated as the end of the film. The end of the metal film facing outwards is designated as the beginning of the film. Analogously, a first primary terminal 31 is connected to the beginning of the metal film B2 and a second primary terminal 32 to the end of the metal film B2.

By suitable selection of the L/C ratio, a resonance frequency of, e.g., 250 Hz, can be set by connecting the LC element W1 to the load capacitor C_{L1}.

In an advantageous variant, an LC element can be built on a magnet core, e.g., made from magnetic iron, see FIG. 4.

An LC element W1 shown schematically in FIG. 4 is formed by a series circuit made from two LC sub-coils W1a, W1b.

The first LC sub-coil W1a includes two electrically conductive films—metal films B1 and B2—which are electrically insulated from each other by a dielectric film 93. In this example, each film includes a three-layer metal film, e.g., Al film. The dielectric films 93 are here formed with two layers.

The composite layers of alternately arranged dielectric films 93 and metal films B1 or B2 are wound in a spiral around a central column 92. These composite layers can have an additional electrically insulating layer 94 pointing outwards and/or inwards towards the central column.

The central column 92 may be arranged with a positive fit on a magnetic core. In this example, the central column 92 of the first LC sub-coil W1a is arranged around a first leg of a (doubly slotted) annular core, with the annular core being formed by two U-cores 91, 91′ and magnetic inserts 98 arranged in-between. An annular core formed in this way is also designated as a UU core.

The second LC sub-coil W1b is built essentially like the first LC coil W1a and arranged about a second leg of the annular core (UU core) lying opposite the first.

The insert 98 is placed in the interior of the central column 92. The insert 98 and the UU core each have different magnetic permeability.

All of the layers of an LC coil, especially the metal foils B1, B2, the dielectric films 93, and the insulating layers 94 can each be composed of, in principle, one layer or several partial layers. For example, in FIG. 4, the insulating layer 94 and the dielectric film 93 are formed with two layers.

All of the windings of the first metal film B1 of the LC sub-coil W1a are connected to an internal terminal 32′, which is arranged on a first end of the LC sub-coil W1a. All of the windings of the second metal film B2 of this LC sub-coil are connected to an internal terminal 34′, which is arranged on a second end of the LC sub-coil W1a. Analogously, from one end the first metal film B1′ of the second LC sub-coil W1b is connected to an internal terminal 33′ and on the opposite end its second metal film B2′ is connected to an internal terminal 31′.

On one side of the component, the internal terminals 32′ and 33′ of the two LC sub-coils W1a, W1b are interconnected by an electrical terminal 96. On the other side of the component, the internal terminals 31′ and 34′ of the two LC sub-coils W1a, W1b are interconnected by an electrical terminal 97.

Therefore, the first metal foil B1 of the first LC sub-coil W1a is connected electrically in series with the first metal film B1′ of the second LC sub-coil W1b. The second metal film B2 of the first LC sub-coil W1a is correspondingly connected electrically in series with the second metal film B2′ of the second LC sub-coil W1b.

The wiring of the individual LC sub-coils W1a, W1b in an LC element W1 is shown schematically in FIG. 5. Three LC elements built according to FIG. 5 can form one star circuit.

FIG. 4 shows that the LC element W1 can be formed as a housed component with a housing 95. The housing 95 can be prepared, e.g., in the form of an aluminum cup with a cover with the external terminals 31 to 34.

In principle, an LC element can include a single LC coil formed as a compact element. The magnetic core can be formed axially.

The functional principle of an LC coil, wherein a capacitor coil acts simultaneously as a choke coil, consists in the fact that a capacitor coil is wound around a magnetic core, for example, an iron core, so that the capacitor coil simultaneously represents a sufficiently high inductance. The inductance is achieved in that the current must flow through all of the windings of the capacitor coil. Thus, it must flow several times around the iron core, with which the windings of a choke coil are simultaneously formed. The construction shown in FIG. 4 distinguishes itself through low weight and low costs.

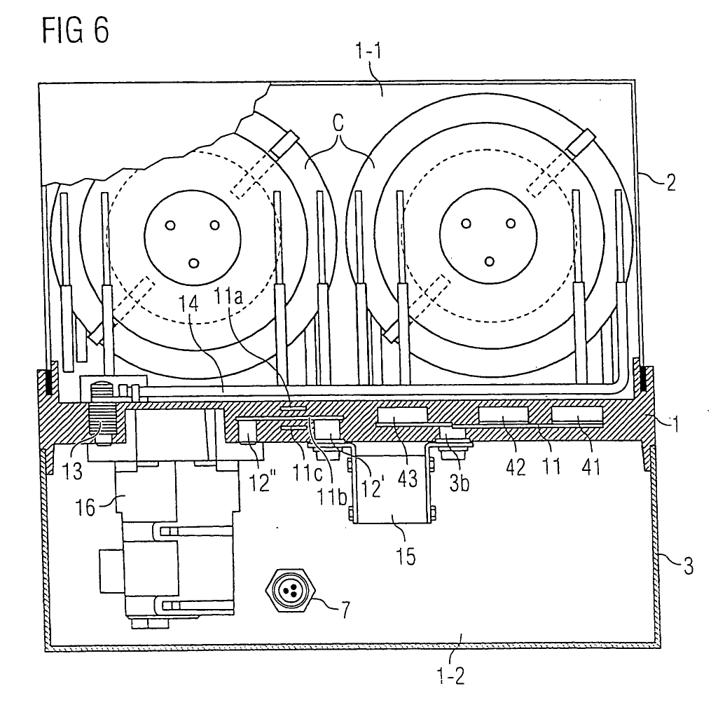

In FIG. 6, an example of a power-factor correction module is shown in a schematic cross section perpendicular to the axes of the phase current conductors 41-43. In this module, a first hollow space or a first module area 1-1 is formed between a first hood 2 and the molded body 1. The first functional group, which is composed of or includes power capacitors, is arranged in this hollow space or area. A second hollow space or a second module area 1-2 is formed between a second hood 3 and the molded body 1. The second functional group, which includes safety devices 15 and a switching device 16 with a, e.g., multiple-pole control terminal 7, is arranged in this hollow space or area. The opposing sides of the molded body 1 (in FIG. 6 the top side and the bottom side) each have a recess for receiving components.

The lead-through 13 is connected on one side to the first functional group by a busbar 14. On the other side, the lead-through 13 is connected electrically to the second functional group. The two functional groups are electrically interconnected by an electrical lead-through 13. The lead-through 13 may be hidden to a large extent in the molded body 1 of the carrier platform. The electrical lead-through 13 is here allocated to the third current phase. There may be a separate electrical lead-through 13 for each current phase.

The separate electrical lead-throughs 13 can provide, in particular, an electrical terminal between a capacitor area, which is also designated as a first module area and which may be hermetically tightly sealed and therefore difficult to access, and a second module area, which is provided with a removable hood and therefore easy to access and which is allocated to the switching devices.

In principle, electrical lead-throughs, parts of the current conductors, and also other metal components optionally integrated in the molded body can also be plugged in. A module component available as a plug element can also be formed with multiple parts and can include, e.g., spring-like elements, such as contact springs.

Components, i.e., safety devices 15, capacitors C, and switching elements are interconnected electrically via supply lines. A first supply line includes a busbar 11a, 11b, 11c, or 14 and vertical contact elements 12′, 12″.

A second supply line includes a current conductor 11 and a vertical contact element 36 and is used for electrical terminal of the third phase current conductor 43 to the safety device 15.

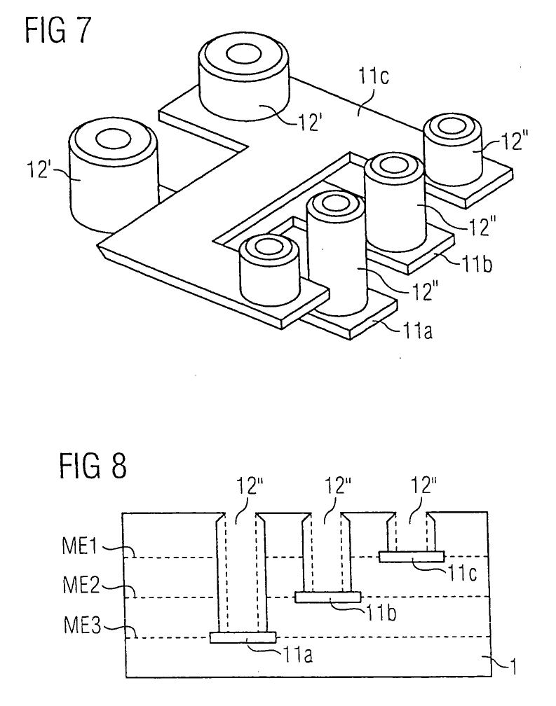

An example construction of a supply line is shown in FIG. 7 in perspective view.

The safety device 15 visible in FIG. 6 is connected by means of vertical contact elements 12, 12′ on one side to the busbar 11 and on the other side to the busbar 11b. The busbar 11b is further connected to a switching element of the switching device 16 by a vertical contact element 12″. The corresponding switching element of the switching device 16 is connected with its other contact to the electrical lead-through 13.

The busbars 11a, 11c of the first supply lines are connected to other safety devices allocated to the first and second current phase and not visible in this figure and to other switching elements of the switching device 16 not visible in this figure, wherein the other switching elements are connected electrically to the corresponding power capacitors or with the corresponding winding of a three-phase power capacitor.

Supply lines, especially the busbars 11 and 11a-11c, can be hidden completely in the molded body 1. The busbar 14 lies bare in the first hollow space in this variant.

In the carrier platform, for multiple or three-phase applications, several metallization levels may be provided, in FIG. 8 three, ME1, ME2, and ME3 (=levels for the electrical lines), which are used as wiring levels for wire-free connection of components to one another or to phase busbars. Two metallization levels are separated by a dielectric layer made from fiber-composite material.

In addition, a power-factor correction unit is disclosed, in which several electrical components are integrated, for example, capacitors or also safety devices, switching contactors, or thyristors, and if necessary, also safety devices. At least a few of the electrical components are interconnected without wires. Such a wire-free connection is realized, for example, with one of the carrier platforms disclosed here, in which rigidly installed busbars are provided. The wire-free connection of electrical components has the advantage that the assembly expense for producing the device or the current compensation module can be reduced, by which production costs can be reduced.

Depending on the application, the hood can be closed tightly with the molded body, e.g., through adhesion or casting, or else embodied as a removable part. A removable hood has the advantage that components arranged underneath can be easily replaced when there is a fault.

In FIG. 6, the first hood 2 projects into the recess of the molded body 1 and is fixed there by casting. A permanent seal adhesion or sealing between the hood, especially a metal cover, and the molded body can be achieved by matching their coefficients of thermal expansion. The coefficient of thermal expansion of the casting may be also matched. Matching the coefficients of expansion means that their relative difference does not exceed a certain value defined by the application.

The second hood 3 is set on the collar of the molded body 1 and, in principle, is removable. In principle, it is also possible to close the second hood tightly to the molded body.

The first hood 2 can also have a removable construction if the exchangeability of the capacitors is desired. In this case, a capacitor coil can be equipped, e.g., with plug contacts.

In FIG. 7, supply lines are formed as contact strips, with vertical contact elements 12′, 12″ are fixed to the busbars 11a, 11b, and 11c, e.g., through welding. The vertical contact elements 12′, 12″ represent hollow cylinders, with a hollow cylinder which may have an internal thread. The vertical contact elements can also be composed of brass.

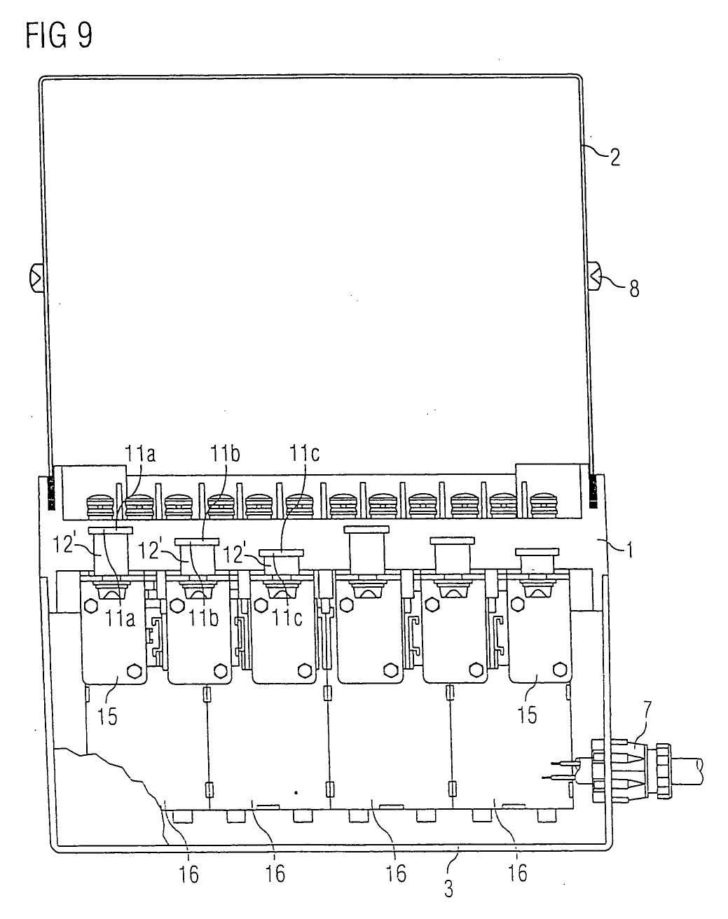

The vertical contact element 12′ of a certain supply line is allocated according to FIGS. 6, 9 to a first installation site, which is provided for the safety device 15. The vertical contact element 12″ is allocated to a second installation site, which is provided for the corresponding switching element of the switching device 16.

FIG. 7 shows that the busbars 11a, 11b, and 11c of different first supply lines can be arranged in different metallization levels. Here, the vertical contact elements 12″ of different supply lines have different heights and are designed so that they are completely enclosed in the molded body 1 of the carrier platform up to their top side. It is also possible for the vertical contact elements to project partially from the platform and carry, e.g., additional mounting devices.

Each of the parallel first supply lines forms a separate contact strip. The busbars of different contact strips may be arranged in different metallization levels and allocated, for example, to a certain current phase. An arrangement of different supply lines in parallel levels allows a compact connection in the module, wherein, in particular, the supply lines allocated to the different current phases are run one above the other and can even cross each other in the vertical projection, with the risk of short circuits being prevented by the intermediate dielectric layer.

One busbar can have branches and in this way more than only two internal terminals or vertical contact elements. The busbar of one supply line can also be welded, e.g., to the busbar of another supply line or a phase busbar.

FIG. 9 shows a schematic cross section of the module from FIG. 6 in a plane running parallel to the direction of the phase busbars 41-43 and vertical to the plane in which the axes of the phase busbars lie. In this variant, two safety devices 15 per current phase connected to the same metallization level, are provided.

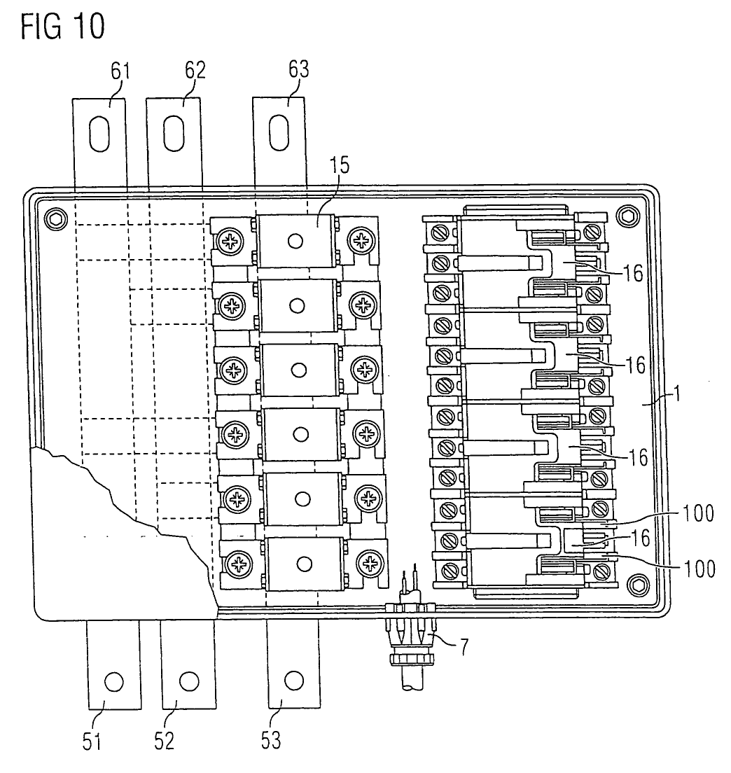

FIG. 10 shows a schematic cross section of the module from FIG. 6 in a plane running parallel to the plane in which the axes of the phase busbars lie.

FIG. 10 also shows separating connectors 100, which are integrated in the carrier platform and may be molded in one piece from the fiber-composite material of the molded body. These separating connectors 100 run parallel to each other and each lengthen the creepage distance between two connections that belong to different contactor switches 16.

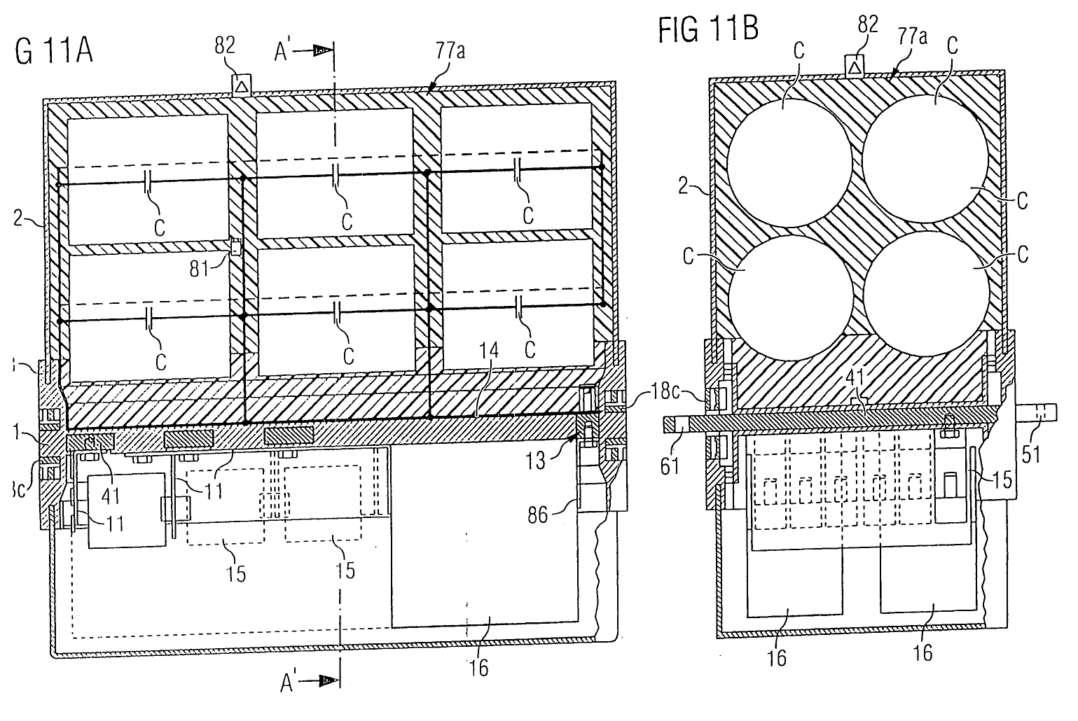

FIG. 11A shows another module in schematic cross section perpendicular to the axes of the phase busbars. FIG. 11B shows this module in schematic cross section parallel to the axes of the phase busbars. Here, several (in total twelve) capacitor coils, which are joined into one capacitor coil package and which form the first functional group of the module, are arranged in a first module area. The capacitor coil package is insulated in this variant from the, e.g., metallic hood 2, such that an intermediate space formed between the capacitor coil package, the carrier platform, and the first hood 2 is filled, e.g., with a molecular sieve granule filling. This filling provides for good thermal coupling of the capacitor coil package to the hood or for good dissipation of the heat generated during operation. This filling is also used for moisture and noise protection. Other suitable fillers, especially cast bodies or resins or granules, can also be used as the filling. The granule filling is shown in FIG. 11A by shading.

To dissipate the heat, sheet-metal parts can also be used in addition to the capacitor coil.

Two inserts 18c are embedded in each of the opposing external walls of the molded body 1.

In the first module area there is a temperature sensor 81 and an overpressure sensor 82 for monitoring the internal pressure. The overpressure sensor 82 or an pressure-relief switch may be arranged in the area of the hood 2.

The overpressure in the first module area builds up due to self-healing breakdowns or in case of overloading due to non-self-healing breakdowns and leads to corresponding bulging of the first hood 2. The overpressure sensor is connected to an external control unit, which outputs a signal for turning off the functional unit to the switching device 16, e.g., via the control terminal 7 from FIG. 9, when there is overpressure in the first module area. The temperature sensor 81 is allocated to a switching unit, e.g., a temperature switching unit that separates the functional unit of the module from the power mains, for example, also by the switching device 16, when there is a thermal overload.

The module can also include, for example, an overpressure tearing safety device, which removes the bulging of the hood 2, i.e., the overpressure in the first module area, e.g., by a membrane or a steel cable for triggering a tearing mechanism when a given threshold of the internal pressure is exceeded. The overpressure tearing safety device may be arranged in an electrical supply or discharge line connected to the capacitor.

The switching device 16 is connected to the lead-through 13 via a supply line 86.

The section A′-A′ of the module presented in FIG. 11A is shown in FIG. 11B. For discharging the heat of the capacitor coils, cooling sheets can be provided. A construction space 77a for a compact, e.g., oil-impregnated LC element with load capacitor is provided. Therefore, the construction space may be closed oil-tight.

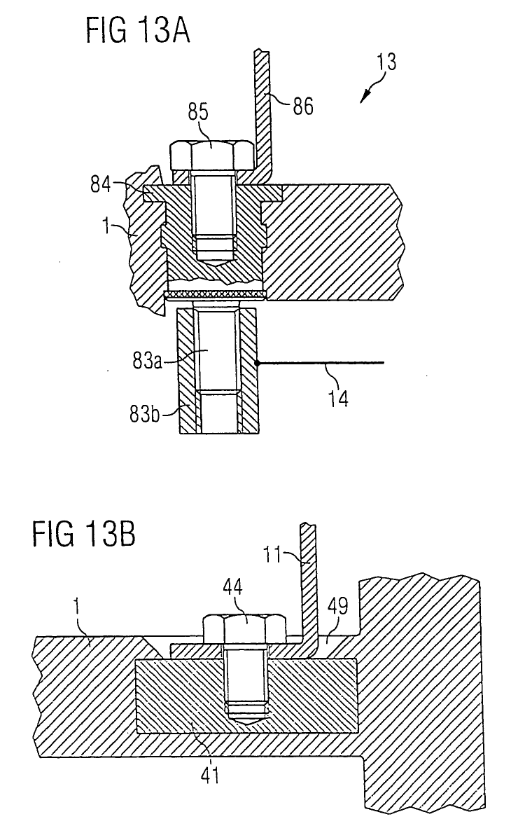

An example construction of the lead-through 13 is shown in FIG. 13A.

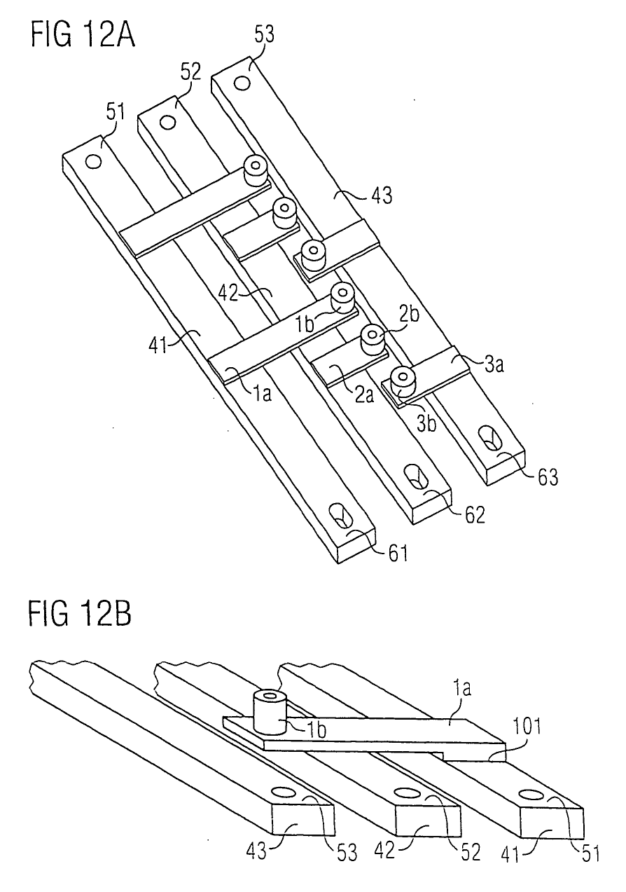

FIG. 12A shows the construction of internal terminals of the phase busbars 41, 42, 43. A busbar 1a is welded on one end to the phase busbar 41. On its opposite end, the busbar 1a is welded to a vertical contact element 1b. The phase busbars 42 and 43 are similarly welded to busbars 2a or 3a. The busbars 2a and 3a each have a vertical contact element 2b or 3b.

The busbars 1a, 2a, 3a run in a projection plane perpendicular to the phase busbars 41 to 43. Here, the busbars 1a, 2a, and 3a—as indicated in FIG. 12B—are formed so that they run partially (especially in the intersecting areas) in a different metallization level than the phase busbars and do not contact the other phase busbars. The busbars 1a to 3a can have, e.g., a spacer 101 or a socket, which is arranged on the corresponding phase busbar and is connected rigidly to this busbar or to the busbar 1a, 2a, 3a.

The vertical contact elements 1b to 3b may have different heights, with each vertical contact element 1b, 2b, or 3b guaranteeing the connection to a separate metallization level corresponding to the current phase. However, the vertical contact elements 1b to 3b can also have the same height and can each have a contact area, which is accessible, e.g., from the surface of the molded body and may be also suitable for mounting components. These vertical contact elements can form, for example, internal terminals of the carrier platform for connecting a component, e.g., a safety device 15.

The configuration of phase busbars can be transferred without additional means to other busbars provided, e.g., as supply lines.

FIG. 13A shows the lead-through 13, which is partially embedded in the molded body 1 of the carrier platform. The lead-through 13 has a plug 83a and a bushing 84 embedded in the molded body 1 of the carrier platform. On the plug 83a there is a bushing 83b, to which the busbar 14 used as a supply line to the capacitors or to the first module area is connected. The bushing 83b may be a round plug contact, which allows the later replacement or repair of capacitor coils.

The bushing 84 of the lead-through 13 is connected electrically and fixed mechanically to the supply line 86 arranged in the second module area and connected to the switching device 16 by means of a screwed threaded bolt 85.

FIG. 13B shows how the first phase busbar 41 can be connected to the busbar 11 by means of a screw 44. In the molded body 1, a recess 49 is provided for forming direct contacts on the phase busbar 41.

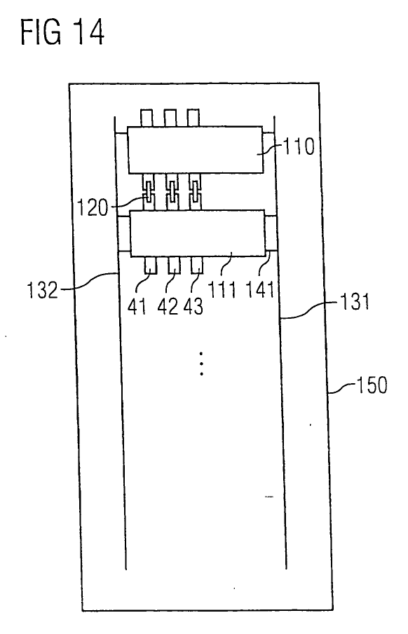

In a schematic view, FIG. 14 shows a phase shifting device with a modular construction. There is a switch cabinet 150, which can be composed of, for example, metal, which offers sufficient space for several individual phase shifter modules 110, 111. The required number of phase shifter modules 110, 111, which is based on the electrical reactive power to be processed, are arranged one above the other and fixed by mounting elements 141 on mounting rails 132, 131. The mounting elements 141 can be fixed in the inserts arranged in the individual phase shifter modules in the housing. The attachment is preferably realized by screw connections.

The individual phase shifter modules 110, 111 are also interconnected by means of contact elements 120. The contact elements 120 interconnect, in particular, the phase busbars 41, 42, 43. In particular, it is advantageous to provide the contact elements 120 for a screw connection with the phase busbars.

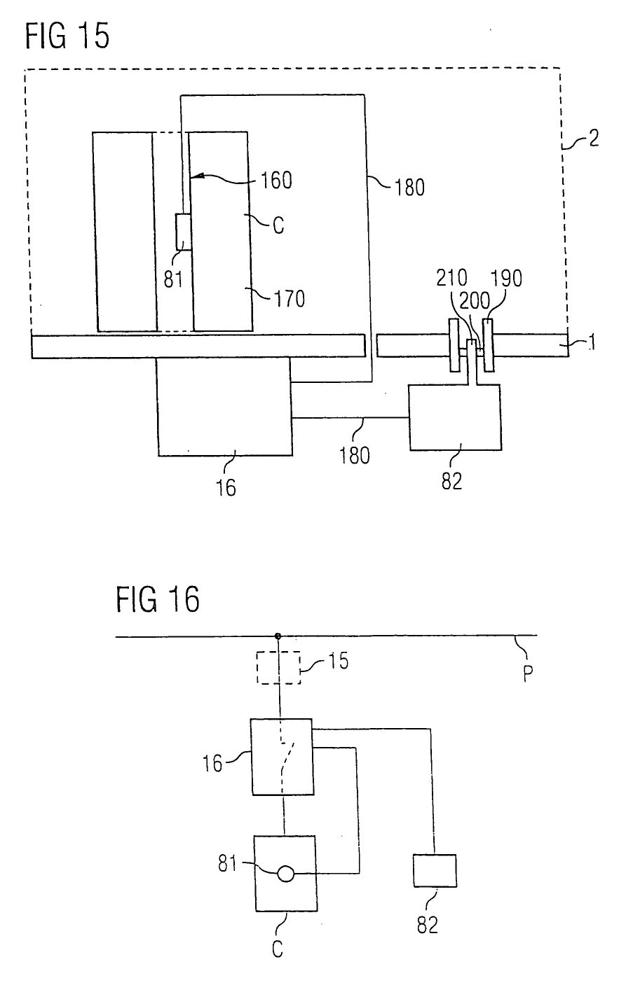

FIGS. 15 and 16 show a safety design in a schematic representation. The molded body 1 of a carrier platform is sealed on the top side by the hood 2 (only shown schematically and with dashed lines). On the top side, a capacitor C is arranged in a hermetically tight part of the arrangement. A leakage rate of 4 to 6×10⁻⁶ mbar×L/sec may be achieved.

This configuration involves, for example, a high-power capacitor. The capacitor includes a capacitor coil 170 which is wound on the outside of a central column 160. The central column is hollow on the inside and provides space for a temperature sensor 81. The temperature sensor 81 here is located approximately in the center of the capacitor, which is also the place where the temperature of the capacitor is greatest when current is flowing. This area is also called a “hot spot.” By placing the temperature sensor 81 in the vicinity of the hot spot, the safety mechanism can be triggered extremely quickly when a certain temperature is exceeded. The resulting heat still must not pass through time-delaying paths in order to be led from the heat source to the temperature sensor 81.

The temperature sensor 81 is coupled by means of a line 180 to a switching device 16, which is provided here only for one example phase P and which connects the phase P to the capacitor. The switching device 16 is essentially composed of a separating switch, which separates the capacitor C from the phase P and thus from the power mains when the switching device responds. When the temperature sensor 81 is triggered, it transmits a signal via the line 180 to the switching device 16 in order to switch off the capacitor in the case of a fault.

In addition, a device is attached to the bottom side of the molded body, that is, in the not necessarily hermetically tight part of the device. However, the overpressure sensor 82 can also be arranged at any other suitable position, especially in the interior of the upper volume of the arrangement or also in the hood 2.

The coupling of the overpressure sensor 82 is realized by means of an insert 190, which is molded from plastic material or from composite material and thus is sealed against the plastic material. In addition, the overpressure sensor 82 includes a pressure sensor 210, which is pushed into the insert and which is sealed by means of a seal 200. The entirety of the molded body 1, insert 190, pressure sensor 210, and seal 200 thus seals the top part of the arrangement from the bottom part, i.e., from the bottom side of the platform.

The overpressure sensor 82 is also coupled to the switching device 16 by means of a line 180 and can thus switch off the capacitor from the phase P when an overpressure appears.

If necessary, another safety device 15 can be connected in series to the switching device 16.

The described devices were explained based on only a few embodiments, but are not limited to these.

All of the aspects and features of the devices can be combined arbitrarily with each other and also with other known measures, e.g., for attaching the components or for realizing lead-through and contact elements. The number of mentioned components and the separate module areas to be formed can vary.

What is claimed is:

1. A platform for holding electrical components, comprising:
a body comprising a fiber-composite material and reinforcing glass fiber;
a busbar in the body, the busbar being part of a group comprised of one or more busbars in the body; and
a contact element associated with the busbar for making contact with the busbar.

2. The platform of claim 1, wherein the busbar is at least partially embedded in the molded body.

3. The platform of claim 1, wherein the contact element comprises a component of the busbar and comprises an open contact area.

4. The platform of claim 3, where the platform comprises plural busbars, at least one of the busbars being embedded in the body with a positive fit.

5. The platform of claim 1, wherein a relative difference in coefficients of thermal expansion between the body and the busbar does not exceed 30%.

6. The platform of claim 5, wherein the contact element is upright relative to the busbar.

7. The platform of claim 6, wherein the contact element is embedded in the body with a form fit.

8. The platform of claim 3, wherein the open contact area comprised an external terminal.

9. The platform of claim 3, wherein the contact element comprises an internal terminal for use in connecting to an electrical component.

10. The platform of claim 1, further comprising:
a hood connected to the platform that defines a housing.

11. The platform of claim 10, further comprising:
electrical components, wherein at least one part of the electrical components is attached to the hood.

12. The platform of claim 1, wherein the platform comprises plural contact elements that are associated with plural busbars that are encased in the fiber-composite material or molded by the fiber-composite material.

13. The platform of claim 1, wherein the contact is at least partially encased in the fiber-composite material or molded by the fiber-composite material.

14. The platform of claim 1, wherein the platform comprises plural busbars:
wherein the body comprises two parts connected mechanically to each other;
wherein recesses facing inwards are formed in at least one of the parts for receiving the plural busbars; and
wherein the two parts of the carrier platform are connected mechanically to the plural busbars.

15. The platform of claim 1, wherein the platform comprises plural busbars:
wherein at least one busbar comprises a phase busbar, the phase busbar comprising external terminals for connecting to a power network having at least one current phase; and
wherein the platform comprises a number of phase busbars that corresponds to a number of current phases of the power network.

16. A module for connecting a network comprised of a power mains to a housing, the module comprising:
a platform for holding electrical components, comprising:
a body comprising a fiber-composite material and reinforcing glass fibers;
a busbar in the body; and
a contact element associated with the busbar for making contact with the busbar;
a hood connected to the body; and
a functional unit in the hood, the functional unit comprising at least one capacitor per current phase of the power mains.

17. The module of claim 16, wherein the module comprises first and second hoods and the functional unit comprises first and second functional groups; and
wherein the module further comprises:
a first module area between the body and the first hood;
a second module area between the body and the second hood;
the first functional group comprising at least capacitors in the first module area; and
the second functional group comprising at least safety devices in the second module area.

18. The module of claim 16, wherein the functional unit comprises inductors.

19. The module of claim 17, wherein the first functional group or the second functional group comprises at least one switching device.

20. The module of claim 17, further comprising:
at least one sensor for detecting a physical parameter, the at least one sensor being in the first module area.

21. The module of claim 20, wherein the at least one sensor comprises a temperature sensor or an overpressure sensor.

22. The module of claim 16, wherein the functional unit comprises discharge resistors or discharge inductors that are each connected in parallel to the at least one capacitor.

23. The module of claim 16, wherein a coefficient of thermal expansion of a busbar differs at most by 4% from a coefficient of thermal expansion of the body.

24. The module of claim 16, wherein the functional unit comprises compact inductive-capacitive (LC) elements comprising at least one LC coil.

25. The module of claim 24, wherein at least one LC element comprises two electrically interconnected LC sub-coils;
wherein the at least one LC element comprises a magnetic annular core; and
wherein the two electrically interconnected LC sub-coils comprise metal films that are wound around different legs of the magnetic annular core.

26. The module of claim 25, wherein the magnetic annular core comprises a UU core; and
wherein the UU core comprises two U cores that face each other with end faces of legs of the two U cores.

27. The module of claim 26, further comprising:
an insert comprised of a magnetic material between the two U cores.

28. The module of claim 24, wherein the at least one LC coil is electrically connected to a load capacitor.

29. (canceled)

30. A power-factor correction device comprising:
a carrier;
unhoused electrical components on the carrier; and
a common housing enclosing the unhoused components.

31. (canceled)

32. The power-factor correction device of claim 30, wherein the unhoused electrical components comprise a thyristor in series with one or more capacitors, the thyristor for electrically connecting the one or more capacitors to a power network.

33. The power-factor correction device of claim 30, wherein the unhoused electrical components comprise substantially identical phase shifter modules electrically connected in series.

34. The power-factor correction device of claim 30, wherein the unhoused electrical components are interconnected without wires.

35. The power-factor correction device of claim 30, which can process reactive power greater than 20 kvar, which has a weight of less than 50 kg, and which has a volume of less than 100 L.
